(19) United States
(12) Patent Application Publication
(10) Pub. No.: US 2022/0264902 A1
(43) Pub. Date: Aug. 25, 2022

(54) Preparation Method for Humic Acid Type Fruit Bagging-free Film Agent and Application thereof

(71) Applicant: Shaanxi University of Science & Technology, Xi'an City (CN)

(72) Inventors: Yuhua Niu, Xi'an City (CN); Long Li, Xingping City (CN); Jie Song, Xi'an City (CN); Yonghui Sun, Xi'an City (CN); Liangxian Huang, Xi'an City (CN); Yuying Han, Xi'an City (CN); Wenchao Wang, Xi'an City (CN)

(21) Appl. No.: 17/564,709

(22) Filed: Dec. 29, 2021

(30) Foreign Application Priority Data
Feb. 25, 2021 (CN) 2021102096013

(51) Int. Cl. A23B 7/16; C09D 105/04

(52) U.S. Cl. CPC A23B 7/16; C09D 105/04

(57) ABSTRACT

A humic acid type fruit bagging-free film agent and an application thereof are provided. The humic acid type fruit bagging-free film agent is prepared by: dissolving sodium alginate into water, adding TWEEN-20 and SPAN-20 after stirring evenly, and stirring for mixing to form sodium alginate solution; dissolving humic acid potassium into water, adding glycerin then mixing to form humic acid potassium solution; stirring the sodium alginate solution and the humic acid potassium solution evenly to form agent A; and dissolving calcium chloride into water to obtain agent B. When in use, the agent A is sprayed onto a fruit surface, and then agent B is sprayed. It can not only be antibacterial, anti- freezing and pest-resistant, but also shorten film-forming duration and have better film-forming property. Shading performance is improved, and problems of rough fruit surface, serious rust and dim color caused by using paper bagging can be solved.

### TECHNICAL FIELD

The invention relates to the technical field of agricultural application, particularly to a humic acid type fruit bagging-free film agent and an application method thereof.

### BACKGROUND

Bagging technology was introduced in China in the 1980s. Fruit bagging can not only prevent fruit from losing water and so on, but also prevent pests from harming fruits. Bagged fruits were once popular in the whole market because of their “safety and good-looking”. However, there are some problems in bagging, such as short time period, heavy tasks, strict operation requirements and shortage of labor force, which greatly restrict the economic cost of fruit farmers. According to fruit bagging technology, many patents at present reduce the cost of manual bagging by adopting mechanical bagging method, which is for example disclosed in a Chinese patent Publication No. CN211580935U. However, although this reduces the labor cost of bagging, it cannot fundamentally solve the problems of serious shading, uneven coloring, fruit relying solely on leaf nutrition, poor fruit taste and quality, etc. existing in bagging with paper film.

Bagging-free film is sprayed to form a thin film evenly and quickly on the surface of fruit. In 2017, another Chinese patent Publication No. CN107155739A proposed by the applicant discloses a bagging-free film with antibacterial ability, which has the characteristics of frost resistance, antibiosis and pest resistance, but there are some defects such as relatively long film forming time and prone to rain washing.

### SUMMARY

In order to overcome the defects in the prior art, an objective of the invention is to provide a humic acid type fruit bagging-free film agent and an application method thereof, which has characteristics of simple operation, low input cost, fast film forming, high film transparency and good flexibility.

Specifically, the invention is realized by that following technical solution:

In an aspect, a humic acid type fruit bagging-free film agent includes an agent A and an agent B, the agent A is configured to be sprayed onto a fruit surface, and then the agent B is configured to be sprayed immediately after the agent A is sprayed to form a humic acid type fruit bagging-free film on the fruit surface.

The agent A is prepared by the following steps:

(1) dissolving sodium alginate into water, stirring evenly, then adding TWEEN-20 and SPAN-20, and stirring for mixing to form a sodium alginate solution;

(2) dissolving humic acid potassium into water completely, adding glycerin, then mixing completely and evenly to form a humic acid potassium solution; and

(3) stirring the sodium alginate solution prepared by the step (1) and the humic acid potassium solution prepared by the step (2) fully until they become a homogeneous system, thereby forming the agent A;

the agent B is a calcium chloride solution.

In an embodiment of the invention, in the step (1), a mass ratio of the sodium alginate: the water: the TWEEN-20: the SPAN-20 is (5˜8): (60˜65): (0.5˜0.8): (0.5˜0.8).

In an embodiment of the invention, in the step (2), a mass ratio of the humic acid potassium: : the water: the glycerin is (0.3˜0.5): (35˜40): (1˜1.2).

In an embodiment of the invention, a volume ratio of the sodium alginate solution prepared in the step (1) to the humic acid potassium solution prepared in the step (2) is 1:1.

In an embodiment of the invention, a mass concentration of calcium chloride in the agent B is (1.5˜2)) %.

In another aspect, the invention further discloses an application method of the humic acid type fruit bagging-free film agent, the humic acid type fruit bagging-free film agent is applied to a fruit surface. When in use, spraying the agent A onto the fruit surface and then spraying the agent B, thereby forming a humic acid type fruit bagging-free film on the fruit surface.

In an embodiment of the invention, when in use, pesticide and micronutrient fertilizer are added into the agent A and mixed then sprayed, before spraying the agent B.

In an embodiment of the invention, a film-forming duration of the humic acid type fruit bagging-free film is 5-10 seconds (s) after spraying the agent A and the agent B.

Compared with the prior art, the invention has the following beneficial technical effects:

The invention takes humic acid, sodium alginate, TWEEN-20, calcium chloride, etc. as the main raw materials. The sodium alginate is a kind of macromolecular polysaccharide extracted from brown algae plants, which has good safety and reproducibility, good film-forming property, high transparency and good flexibility. The calcium chloride can not only play the role of cross-linking and film-forming, but also supplement calcium for fruit growth to prevent fruit cracking. The humic acid as a natural high molecular material has good biostimulant effect and antibacterial effect, and has the function of complexing metal ions to improve the utilization rate of nutrients in fruits. Furthermore, the humic acid may improve the content of trace elements and the ability of water and fertilizer conservation.

The humic acid type fruit bagging-free film agent prepared by the invention may form a protective film with strong ductility, good shading, good air permeability and good isolation effect on the surface of the fruit by alternately spraying. Compared with the above-mentioned Chinese patent Publication No. CN107155739A applied by the applicant earlier, it not only has the characteristics of antibacterial, antifreeze and pest resistance, but also shortens its film-forming duration and has better film-forming property. The shading performance is also correspondingly improved, which can not only expose the fruit surface to scattered light, but also partially shade the fruit surface to prevent it from being burned by strong light. The raw materials used are natural, environment-friendly, nontoxic and harmless, which makes up for the defects of bagging technology and prevents environmental pollution under the condition of ensuring the safety and practicality of fruits. In addition, this humic acid fruit bagging-free film is sensitive to pH, and may be quickly crosslinked to form a film under the condition of partial acidity, while it may be automatically crosslinked under the condition of partial alkalinity, so it may be widely applied in fruit bagging-free technology. The humic acid type fruit bagging-free film agent in this invention can not only has the characteristics of conventional bagging, such as delicate and smooth fruit surface, pleasing and bright color, prevention of plant diseases and insect pests, reduction of pesticide volume, etc., but also solve the problems of rough fruit surface, serious water rust, dim color, etc. caused by rainwater wetting and lax sealing existing in paper bagging.

The humic acid type fruit bagging-free film agent and application method of the invention have the characteristics of simple operation, low investment cost, fast film-forming speed, can be mixed with various pesticides and micro fertilizers, high respiratory frequency, early coloring, good coloring, good taste and long fruit preservation period.

### DETAILED DESCRIPTION OF EMBODIMENTS

The invention relates to a humic acid type fruit bagging-free film agent and an application method of humic acid type fruit bagging-free film agent. The humic acid type fruit bagging-free film agent (also referred to as bagging-free film agent for humic acid type fruit) exemplarily consists of agent A and agent B. In actual use, the agent A is sprayed first and then the agent B is sprayed, and at the same time, the agent A can be mixed with pesticide and micronutrient fertilizer for use, and a film may be quickly formed within 3-10 seconds (s).

A principle of the invention is as follows: calcium chloride, as a cross-linking agent of sodium alginate, will chelate with the sodium alginate. The composite crosslink system of humic acid macromolecule and linear natural macromolecule sodium alginate as lamellar structure mainly exists in the form of hydrogen bond, and form a three-dimensional network crosslinking structure. Because active groups of the sodium alginate are evenly distributed in the cross-linked composite system, after contacting with calcium chloride, molecular chains of the sodium alginate are more tightly combined and the synergy is stronger. Therefore, the interaction between chains eventually leads to the formation of a three-dimensional grid structure, that is, the gel state, which makes the prepared liquid film have good tensile strength, thickness and flexibility, thus greatly improving the comprehensive performance of the product film.

Specifically, the preparation method of the humic acid type fruit bagging-free film agent may include the following steps:

(1) dissolving sodium alginate into water, stirring evenly, then adding TWEEN-20 (also referred to as polysorbate-20, its molecular formula is C₂₆H₅₀O₁₀) and SPAN-20 (also referred to as sorbitan monolaurate, its molecular formula is C₈H₃₄O₆), and stirring for mixing to form a sodium alginate solution, where a mass ratio of the sodium alginate: the water: the TWEEN-20: the SPAN-20 is (5˜8): (60˜65): (0.5˜0.8): (0.5˜0.8);

(2) dissolving humic acid potassium into water completely, adding glycerin, then mixing completely and evenly to form a humic acid potassium solution, where a mass ratio of the humic acid potassium: the water: the glycerin is (0.3˜0.5): (35˜40): (1˜1.2);

(3) stirring the sodium alginate solution prepared by the step (1) and the humic acid potassium solution prepared by the step (2) fully until they become a homogeneous system, thereby forming the agent A, where a volume ratio of the sodium alginate solution prepared in the step (1) to the humic acid potassium solution prepared in the step (2) is 1:1; and

(4) dissolving calcium chloride into water to obtain the agent B. In an application, spraying the agent A is carried out before spraying the agent B onto the fruit surface, where a mass concentration of the calcium chloride is (1.5˜2) %.

The invention will be further described in detail with specific embodiments, which are meant to explain the invention rather than limit it.

### Embodiment 1

(1) 5 kg of sodium alginate is dissolved into 60 kg of water, 0.5 kg of TWEEN-20 and 0.5 kg of SPAN-20 are added, fully dissolved, stirred for mixing to form a sodium alginate solution;

(2) 0.3 kg of humic acid potassium is dissolved into 40 kg of water, mixed evenly, 1 kg of glycerin are added, and stirred evenly to obtain a humic acid potassium solution;

(3) the sodium alginate solution prepared by step the (1) and the humic acid potassium solution prepared by the step (2) are fully stirred according to a volume ratio of 1:1 until they become a homogeneous system, thereby forming agent A; and

(4) 1.5 kg of calcium chloride is dissolved into 100 kg of water, fully dissolved, and thereby obtaining agent B.

### Embodiment 2

(1) 8 kg of sodium alginate is dissolved into 65 kg of water, 0.8 kg of TWEEN-20 and 0.8 kg of SPAN-20 are added, fully dissolved, stirred for mixing to form a sodium alginate solution;

(2) 0.5 kg of humic acid potassium is dissolved into 35 kg of water, mixed evenly, 1.2 kg of glycerin are added, and stirred evenly to obtain a humic acid potassium solution;

(3) the sodium alginate solution prepared by the step (1) and the humic acid potassium solution prepared by the step (2) are fully stirred according to a volume ratio of 1:1 until they become a homogeneous system, thereby forming agent A; and

(4) 2 kg of calcium chloride is dissolved into 100 kg of water, fully dissolved, and thereby obtaining agent B.

### Embodiment 3

(1) 6 kg of sodium alginate is dissolved into 60 kg of water, 0.6 kg of TWEEN-20 and 0.6 kg of SPAN-20 are added, fully dissolved, stirred for mixing to form a sodium alginate solution;

(2) 0.4 kg of humic acid potassium is dissolved into 40 kg of water, mixed evenly, 1.1 kg of glycerin are added, and stirred evenly to obtain a humic acid potassium solution;

(3) the sodium alginate solution prepared by the step (1) and the humic acid potassium solution prepared by the step (2) are fully stirred according to a volume ratio of 1:1 until they become a homogeneous system, thereby forming agent A; and

(4) 1.8 kg of calcium chloride is dissolved into 100 kg of water, fully dissolved, and thereby obtaining agent B.

### Embodiment 4

(1) 7 kg of sodium alginate is dissolved into 63 kg of water, 0.8 kg of TWEEN-20 and 0.8 kg of SPAN-20 are added, fully dissolved, stirred for mixing to form a sodium alginate solution;

(2) 0.3 kg of humic acid potassium is dissolved into 37 kg of water, mixed evenly, 1.0 kg of glycerin are added, and stirred evenly to obtain a humic acid potassium solution;

(3) the sodium alginate solution prepared by the step (1) and the humic acid potassium solution prepared by the step (2) are fully stirred according to a volume ratio of 1:1 until they become a homogeneous system, thereby forming agent A; and

(4) 2 kg of calcium chloride is dissolved into 100 kg of water, fully dissolved, and thereby obtaining agent B.

The application performance test of the humic acid type fruit bagging-free film agent is conducted in the demonstration area of Baota District, Yan'an, Shaanxi Province, China, and the experimental crop is apple. The control group bags apples with conventional plastic bags. The experimental group 1 uses the bagging-free film prepared by the applicant's earlier Chinese patent Publication No.CN107155739A. The experimental group 2 takes the products prepared in Embodiment 1, and apples are subject to spraying to form films. The effects of different bagging methods on apple growth are observed and explored.

The experimental results are as follows.

(a) the bagging-free film applied in the experimental group 1 takes 0.8-1h to form a film after spraying, and the humic acid fruit bagging-free film applied in experimental group 2 may quickly form a film within 5 s after spraying, which greatly shortens the film forming duration.

(b) the apples are observed after bagging and spraying agents to form film, it is found that the apples in the two experimental groups grow relatively well, and the apples in the experimental group 2 develop rapidly. From the 40th day after bagging, it is observed that the apples are relatively larger in size and have a higher rate of full red in the colored area. The specific experimental results are shown in Table 1.

TABLE 1
Growth of apples after bagging

| Group/Days | 20 | 30 | 40 | 50 | 60 | 70 |
|---|---|---|---|---|---|---|
| Control group | Good | Good | With poor | With poor | With poor | With poor |
| | growth | growth | color and | color and | color, many | color, many |
| | | | spots | spots | spots and | spots and |
| | | | | | fruit | fruit |
| | | | | | dropping. | dropping. |
| Experimental | Good | Good | Good | Good | Good | Good |
| group 1 | growth | growth | growth, with | growth, with | growth, with | growth, with |
| | | | relatively full | relatively full | relatively full | relatively full |
| | | | fruit and | fruit and | fruit and | fruit and |
| | | | transparent | transparent | transparent | transparent |
| | | | color. | color. | color. | color. |
| Experimental | Good | Good | With | With | With big | With big |
| group 2 | growth | growth | relatively | relatively | fruit, smooth | fruit, shallow |
| | | | big fruit, | big fruit, | surface, | and small |
| | | | smooth | smooth | shallow and | fruit dots, |
| | | | surface and | surface and | small fruit | and bright |
| | | | bright color. | bright color. | dots and | color. |
| | | | | | bright color | |

From the table, it can be seen that the fruit of experimental group 2 is bigger, the fruit surface is smoother, the fruit develops faster, larger than that of bagged apples and experimental group 2, the specific gravity is larger, the fruit surface is smooth and delicate, the fruit dot is shallow and small, and the color is bright.

(c) the sweetness and hardness of apples in the control group, the experimental group 1 and the experimental group 2 are tested, and the test results are shown in Table 2.

TABLE 2

| | Sugar content | Average hardness |
|---|---|---|
| Group | (%) | (kgf/cm²) |
| Control group | 10.6 | 6.73 |
| Experimental group 1 | 13.7 | 8.16 |
| Experimental group 2 | 16.3 | 9.77 |

It can be seen from the table that the bagging-free film prepared by the above-mentioned Chinese patent Publication No. CN107155739A in the experimental group 1 and humic acid fruit bagging-free film prepared in the experimental group 2 may improve the sugar content and hardness of apples. Compared with the bagging-free film previously proposed by the applicant, the performance of humic acid fruit bagging-free film prepared by the invention is improved, and the preparation method is also improved. The applicable fruits are not limited to apples, but also may be applied to kiwi fruit, pear, pomegranate, grape and other fruits.

What has been described above is only the illustrated embodiment of the invention, and it does not limit the invention in any way. Any simple modification, change and equivalent structural transformation of the above embodiments according to the technical essence of the invention still falls within the protection scope of the technical solution of the invention.

1. A humic acid type fruit bagging-free film agent, comprising: an agent A and an agent B, wherein the agent A is configured to be sprayed onto a fruit surface, and then the agent B is configured to be sprayed immediately after the agent A is sprayed to form a humic acid type fruit bagging-free film on the fruit surface;
wherein the agent A is prepared by the following steps:
(1) dissolving sodium alginate into water, stifling evenly, then adding TWEEN-20 and SPAN-20, and stifling for mixing to form a sodium alginate solution; wherein a mass ratio of the sodium alginate: the water: the TWEEN-20: the SPAN-20 is (5˜8): (60˜65): (0.5˜0.8): (0.5˜0.8);
(2) dissolving humic acid potassium into water completely, adding glycerin, then mixing completely and evenly to form a humic acid potassium solution; wherein a mass ratio of the humic acid potassium: the water: the glycerin is (0.3˜0.5): (35˜40): (1˜1.2); and
(3) stifling the sodium alginate solution prepared by the step (1) and the humic acid potassium solution prepared by the step (2) fully until they become a homogeneous system, thereby forming the agent A; wherein a volume ratio of the sodium alginate solution prepared in the step (1) to the humic acid potassium solution prepared in the step (2) is 1:1;
wherein the agent B is a calcium chloride solution.

2. The humic acid type fruit bagging-free film agent according to claim 1, wherein a mass concentration of calcium chloride in the agent B is (1.5˜2) %.

3. An application method of the humic acid type fruit bagging-free film agent according to claim 1, wherein the humic acid type fruit bagging-free film agent is applied to a fruit surface;
wherein when in use, spraying the agent A onto the fruit surface and then spraying the agent B, thereby forming a humic acid type fruit bagging-free film on the fruit surface.

4. (canceled)

5. The application method according to claim 3, wherein a film-forming duration of the humic acid type fruit bagging-free film is 5-10 seconds (s) after spraying the agent A and the agent B.
